(19) United States
(12) Patent Application Publication
(10) Pub. No.: US 2026/0225573 A1
(43) Pub. Date: Aug. 6, 2026

(54) METHOD OF DETECTING WEAR AND TEMPERATURE OF A BRAKING MEMBER OF A VEHICLE, CORRESPONDING DETECTION UNIT AND COMPUTER PROGRAM PRODUCT

(71) Applicant: C.R.F. Società Consortile per Azioni, Orbassano Torino (IT)

(72) Inventors: Massimo GRILLO, Orbassano Torino (IT); Renato BADINO, Torino (IT)

(21) Appl. No.: 19/152,676

(22) PCT Filed: Jan. 17, 2024
(86) PCT No.: PCT/IB2024/050450

§ 371 Date: Jul. 31, 2025

(30) Foreign Application Priority Data
Feb. 2, 2023 (IT) 102023000001701

(51) Int. Cl. B60T 17/22

(52) U.S. Cl. CPC B60T 17/221

(57) ABSTRACT

A wear and temperature sensor of a braking member of a vehicle includes detection electric circuits arranged in an ordered sequence. Each circuit includes a wear detector, and a subset of the circuits includes a temperature detector. Resistance values of the circuits are sensed and an N-bit binary sequence is produced, N being the number of circuits. The bits of the N-bit binary sequence are orderly associated, from a most to a least significant bit, to the ordered sequence of the circuits. Each bit of the sequence takes on the value “1” if the corresponding circuit is electrically continuous and the value “0” if the corresponding circuit is electrically interrupted. In the N-bit binary sequence, the most significant bit amongst those with the value “1” is identified, and the wear degree of the braking element is determined as a function of a position of the identified bit in the binary sequence.

### FIELD OF THE INVENTION

The present invention relates to a unit for detecting wear and temperature of a braking member of a vehicle, for example a brake pad or a brake shoe for a drum brake or other friction braking member, and in particular it relates to a method for detecting the wear and temperature of the braking member as a function of a plurality of electrical signals provided by a sensor arranged in the braking member itself.

### PRIOR ART

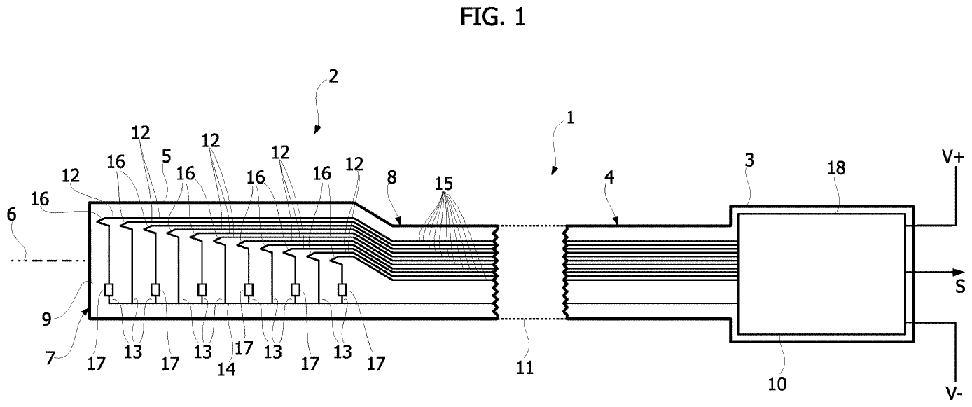

Units for detecting wear and temperature of a braking member (also referred to as “brake pad” in the following, only for brevity) of the above-mentioned type are known in the art, for example from document EP 3948007 B1. FIG. 1 schematically illustrates two opposite end portions of the known detection unit, with parts removed for clarity (such as the intermediate part). The detection unit 1 comprises a detection sensor 2, an electrical connector 3 suitable for connecting the detection unit 1 to an electronic control unit (ECU) of the vehicle, and an electrical wiring 4 suitable for connecting the detection sensor 2 to the electrical connector 3. The detection sensor 2 comprises a body 5, preferably cylindrical, which is configured to be inserted and locked in a space of the brake pad in such a way that the longitudinal axis 6 of the sensor 2 extends orthogonally to the rubbing surface 7 between the pad and disk. The detection unit 1 comprises a flexible band 8 (for example, polymeric) that has a first end section 9 embedded in the body 5 of the sensor 2, a second end section 10 opposite to the first one that extends inside the electrical connector 3 of the detection unit 1, and an intermediate section 11 that extends between the body 5 of the sensor 2 and the electrical connector 3. On the first terminal section 9 of the flexible band 8, embedded in the sensor 2, a row of detection electric circuits 12 independent of each other is arranged. The detection electric circuits 12 are arranged in cascade along the longitudinal axis 6 of the sensor 2 starting from its front surface 7 (i.e., the surface facing the brake disk) and are produced by depositing electrically conductive material on an outer surface of the flexible band 8. The detection electric circuits 12 have respective first ends 13 all electrically coupled to a conductive track 14 arranged in the body 5 of the sensor 2 parallel to the longitudinal axis 6, and second ends 15 electrically isolated from each other. The first ends 13 of the detection circuits 12 are biased to a first voltage V-received via the electrical connector 3, and the second ends 15 of the detection circuits 12 are biased to a second voltage V+ received via the electrical connector 3. Each detection circuit 12 comprises a wear detector 16, i.e., a section of the circuit 12 which, when worn following the progressive wear of the brake pad wherein the sensor 2 is arranged, opens the respective circuit 12 (i.e., electrically isolates the first end 13 from the second end 15 of circuit 12). Each detection circuit 12 (or a subset thereof) further comprises a temperature detector 17 (e.g., a resistance thermometer). An electronic control unit 18 (e.g., a microprocessor) is electrically coupled to the detection circuits 12 in such a way as to emit, during the wear of the brake pad, an output signal S that depends on the wear and temperature of the pad itself. In particular, wear is determined by the microprocessor 18 by detecting the electrical continuity at the ends of the detection circuits 12, which will progressively be interrupted due to wear. The temperature is determined as a function of the resistance value of the resistance thermometer arranged in the intact detection circuit 12 which, from time to time, is the closest to the rubbing surface 7 between the pad and disk.

Further sensors for detecting wear and temperature of a braking member are described in documents US 2018/0128334 A1 and U.S. Pat. No. 5,559,286 A.

In the known sensor described above, errors can occur in the reading of the wear and/or temperature value of the brake pad due to possible faults in the sensor itself (for example, the interruption of one or more of the detection circuits due to different causes from wear). In such cases, the information provided to the driver of the vehicle is incorrect.

Therefore, methods for detecting wear and temperature of a braking member, through the use of a sensor such as the one described above, are desirable, which are fast, reliable and simple, and are not very expensive in terms of computational resources (i.e., use little memory of the microprocessor) and are able to detect possible faults of the individual detection circuits.

### OBJECT OF THE INVENTION

The object of the present invention is to provide an improved method for detecting wear and temperature of a braking member, which is more robust, faster and more reliable than known methods and allows the detection of possible faults in the sensor used for the detection.

### SUMMARY OF THE INVENTION

According to an aspect, the subject of the invention is a method, possibly implemented by an electronic unit (e.g. a microprocessor), for detecting wear and temperature of a braking member. According to the method, the resistance values of a set of detection electric circuits arranged in an ordered sequence along an axis of a detection sensor are sensed. Each of the detection electric circuits comprises a respective wear detector for the braking member. Each of the detection electric circuits in a subset of the detection electric circuits comprises a respective temperature detector of the braking member. A first detection electric circuit of the ordered sequence is arranged towards a rubbing surface of the braking member and a last detection electric circuit of the ordered sequence is arranged towards a support back plate of the braking member. A N-bit binary sequence is produced, where N is the number of detection electric circuits. The bits of the binary sequence are orderly associated, from a most significant bit to a least significant bit, to the ordered sequence of detection electric circuits. Each bit of the binary sequence takes on a first logic value (e.g., “1”) if the corresponding detection electric circuit is electrically continuous and a second logic value (e.g., “0”) if the corresponding detection electric circuit is electrically interrupted. In the N-bit binary sequence, a most significant bit is identified amongst the bits having the first logic value, and the wear degree of the braking element is determined as a function of the position of the identified bit in the binary sequence. A further most significant bit amongst the bits having the first logic value is identified, in a subset of the N-bit binary sequence corresponding to the subset of detection electric circuits, and the temperature of the braking element is determined as a function of the resistance of the temperature detector associated to the detection electric circuit corresponding to the further most significant bit. A set of allowable cases for the N-bit binary sequence is stored, the N-bit binary sequence is compared to the stored allowable cases, and an error message is produced if the N-bit binary sequence does not correspond to any of the stored allowable cases.

According to another aspect, the subject of the invention is a unit for detecting the wear and temperature of a braking member. The detection unit comprises a detection sensor, an electrical connector configured to connect the detection unit to an electronic control unit of the vehicle, and an electrical wiring configured to connect the detection sensor to the electrical connector. The detection sensor comprises a body having a longitudinal axis and configured to be inserted into the braking member, and a set of detection electric circuits arranged in the body in an orderly sequence along the longitudinal axis. The detection electric circuits have respective first terminals all electrically coupled to a conductive track arranged in the body of the detection sensor and configured to receive a first power supply voltage, and respective second terminals electrically isolated from each other and configured to receive a second power supply voltage. Each of the detection electric circuits comprises a respective wear detector of the braking member, and each of the detection electric circuits in a subset of the detection electric circuits comprises a respective temperature detector of the braking member. A first detection electric circuit of the ordered sequence is arranged towards a rubbing surface of the braking member and a last detection electric circuit of the ordered sequence is arranged towards a support back plate of the braking member. The electrical connector comprises a microprocessor coupled to the detection electric circuits to sense their resistance values and a transceiver coupled to the microprocessor. The microprocessor is configured to operate according to the method of any of the embodiments, and the transceiver is configured to transmit a message indicative of the wear degree and temperature of the braking member to an electronic control unit of the vehicle.

According to another aspect, the subject of the invention is a corresponding computer program product that can be loaded into a memory of at least one processing device (for example, a microprocessor of the detection unit) and comprising software code instructions for carrying out the steps of the method according to one or more embodiments when the product is executed by the at least one processing device. As used herein, a reference to such a computer program product is intended to be equivalent to a reference to a computer-readable medium that contains instructions for controlling the processing device for the purpose of coordinating the implementation of the method according to one or more embodiments. A reference to “at least one processing device” is intended to highlight the possibility that one or more embodiments are implemented in a modular and/or distributed form.

### DETAILED DESCRIPTION OF THE INVENTION

Further features and advantages of the invention will emerge from the following description with reference to the attached drawings, provided purely by way of non-limiting example, wherein:

FIG. 1, previously described, illustrates a unit for detecting wear and temperature of a braking member according to the prior art;

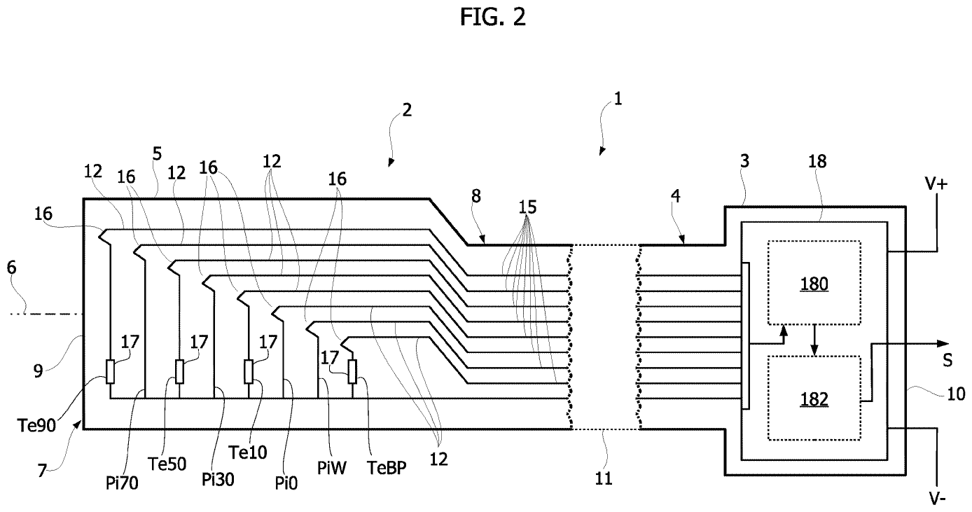

FIG. 2 illustrates a unit for detecting wear and temperature of a braking member according to one or more embodiments of the present invention; and

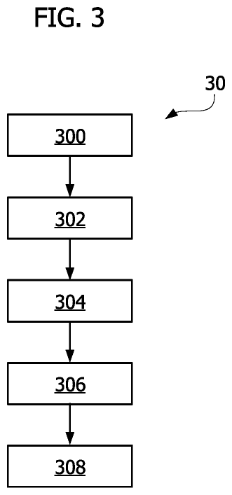

FIG. 3 illustrates a flow diagram of a method for detecting wear and temperature of a braking member according to one or more embodiments of the present invention.

As mentioned, one or more embodiments relate to a method for detecting wear and temperature of a braking member (e.g., a brake pad) via a detection unit as illustrated in FIG. 2, wherein parts corresponding to those of FIG. 1 are indicated with the same reference numerals, and a corresponding description is not repeated for brevity. Furthermore, any differences in the sizing (e.g., proportions) of such parts between different figures should not be interpreted as implying a structural difference, but may be due (solely) to greater clarity of representation.

As previously described, a row of detection electric circuits 12 independent of each other is arranged on the end section 9 of the flexible band 8 embedded in the sensor 2. Each detection circuit 12 comprises a wear detector 16 and, optionally, a temperature detector 17 (e.g., a resistance thermometer). It will be noted that the presence of a wear detector 16 in each circuit 12 is almost implicit, as the electrical continuity of each circuit 12 is in fact compromised by the progressive wear of the brake pad, regardless of the specific shape of the portion 16 of the circuit 12, exemplified here as a “V”. In the example considered here, sensor 2 comprises:
a first circuit 12 comprising a wear detector 16 and a resistance thermometer Te90, arranged at 90% of the usable thickness of the brake pad (starting from surface 7 when the sensor 2 is intact);
a second circuit 12 comprising a wear detector 16 and a conductive track Pi70, arranged at 70% of the usable thickness;
a third circuit 12 comprising a wear detector 16 and a resistance thermometer Te50, arranged at 50% of the usable thickness;
a fourth circuit 12 comprising a wear detector 16 and a conductive track Pi30, arranged at 30% of the usable thickness;
a fifth circuit 12 comprising a wear detector 16 and a resistance thermometer Te10, arranged at 10% of the usable thickness;
a sixth circuit 12 comprising a wear detector 16 and a conductive track Pi0, arranged at 0% of the usable thickness (i.e., the usability limit of the brake pad, beyond which the pad must be replaced—e.g., when the residual thickness of the pad is of the order of 2.6 mm);
a seventh circuit 12 comprising a wear detector 16 and a conductive track PiW, arranged between 0% of the usable thickness of the brake pad and the back plate (or support or support back plate) of the brake pad (e.g., at an alert threshold); and
an eighth circuit 12 comprising a wear detector 16 and a resistance thermometer TeBP, arranged at the back plate of the brake pad (e.g., at the end of the friction material of the brake pad, i.e., the eighth circuit can be “sunk” in steel).

The electronic control unit 18 is electrically coupled to the detection circuits 12 in such a way as to emit, during use of the vehicle and depending on the progressive wear of the brake pad, an output signal S which depends on the wear and temperature of the pad itself. The electronic control unit 18 receives a power supply voltage between two power supply terminals V+ and V− (e.g., positive terminal and reference or ground or grounding terminal). The power supply voltage, possibly regulated and/or rescaled, is used to power the internal circuits of the unit 18 and to bias the detection circuits 12. As previously described, wear is determined by the unit 18 by detecting electrical continuity at the ends of the detection circuits 12. In particular, the unit 18 comprises a microprocessor 180 and a LIN (Local Interconnect Network) transceiver 182. The microprocessor 180 is electrically coupled to the circuits 12 to detect their electrical continuity (i.e., substantially, the resistance value), and executes an algorithm (e.g., implemented by the microprocessor firmware) which processes the data received from each circuit 12 and produces an output signal in the LIN format. The signal in LIN format is transmitted to the LIN transceiver 182 and from there it is transmitted as an output signal S to a control unit (ECU) of the vehicle via a LIN bus. The output signal S in particular transmits information about the identifier of sensor 2 (on the basis of which the vehicle identifies the braking member from which the information comes, for example front left, front right, rear left or rear right), the wear degree of the brake pad, the temperature of the brake pad, and the detection of possible faults in sensor 2.

In particular, the microprocessor 180 is configured to associate to each detection circuit 12, depending on its resistance value, a digital (logic) value indicative of the fact that the circuit is electrically continuous, i.e., intact (e.g., logic “1”) or is electrically interrupted, i.e., worn or damaged (e.g., logic “0”). The sequence of digital values produces an N-bit binary code, where N is the number of detection circuits 12 (e.g., 8 bits in the example in FIG. 2). In particular, the binary code can be structured in such a way that the most significant bit (MSB) is associated to the first circuit 12, i.e., the one closest to the surface 7, and the least significant bit (LSB) is associated to the last (e.g., eighth) circuit 12, i.e., the one closest to the back plate of the brake pad. For example, when the brake pad is new and intact, the microprocessor 180 produces the binary code “11111111”, corresponding to the base-10 value 255, as per Table I shown at the end of the description.

If, however, the brake pad is slightly worn and the detection circuit 12 closest to the brake disk (i.e., the circuit comprising the resistance thermometer Te90) is worn to the point of being electrically discontinuous (i.e., open), the microprocessor 180 produces the binary code “01111111”, corresponding to the base-10 value 127, as per Table II shown at the end of the description.

Again by way of example, if the brake pad is worn to the limit of its usable thickness and the detection circuit 12 comprising the conductive track Pi0 is worn to the point of being electrically discontinuous, the microprocessor 180 produces the binary code “00000011”, corresponding to the base-10 value 3, as per Table III shown at the end of the description. Substantially, assuming that no errors or faults occur in the sensor 2, only eight binary codes (and the corresponding eight base-10 numerical values) are “acceptable” for the microprocessor 180, i.e., the codes wherein the bits having value “0” (if present) are consecutive and arranged starting from the most significant bit, as per Table IV shown at the end of the description. It will be noted that the code wherein all the bits take on the value “0” is not considered acceptable, as the least significant bit indicates the electrical integrity of circuit 12 corresponding to the back plate of the brake pad, which is not wearable (being “sunk” in the steel and not in the friction material of the pad).

Any other binary code (and any other base-10 numeric value) other than those listed in Table IV identifies a sensor operation error, as it indicates that a certain detection circuit 12 is open when at least one other detection circuit 12 that is closer to the surface 7 contacting to the brake disk is still closed (or, in the case of code with all the bits equal to “0”, it would indicate wear of the circuit 12 embedded in the back plate-which cannot occur). As an example, the binary code “11011111” would indicate wear of the resistance thermometer Te50 when the resistance thermometer Te90 and the conductive track Pi70 are not yet worn, which is incompatible with the expected operation of sensor 2, which wears progressively along the direction of the longitudinal axis 6 starting from the surface 7.

Therefore, as exemplified in the flow diagram of FIG. 3, in a step 300 of the detection method 30 the microprocessor 180 is configured to store, in a respective memory area, the numerical values (in base-10) allowable in the form 2ⁿ-1 with n=1, . . . , N (e.g., eight numeric values 1, 3, 7, 15, 31, 63, 127, 255 for N=8).

In a step 302, the microprocessor 180 detects the electrical continuity of the circuits 12 and produces the corresponding binary code, assigning the logic value “1” to each closed circuit and the logic value “0” to each open circuit, with the most significant bit (MSB) corresponding to the detection circuit closest to the rubbing surface 7 (e.g., the circuit comprising the resistance thermometer Te90) and the least significant bit (LSB) corresponding to the detection circuit closest to the back plate of the brake pad (e.g., the circuit comprising the resistance thermometer TeBP).

In a step 304, the microprocessor 180 determines the wear value of the brake pad by selecting the bit having the greatest weight (i.e., the most significant one) amongst all the bits having the value “1” in the binary code produced in step 302. The search for the bit “1” having the greatest weight can be carried out in various ways, implemented by the firmware of the microprocessor 180. For example, the microprocessor can examine the values of the bits of the binary code starting from the most significant bit, and stop the search as soon as it detects a bit having logic value “1”. Alternatively, the microprocessor can multiply each bit of the binary code times a corresponding coefficient, these coefficients having respective values that increase as the significance of the bit increases (i.e., the larger coefficient being associated to the MSB and the smaller coefficient being associated to the LSB), thus producing a set of weighted values; the wear value can therefore be selected as the value corresponding to the bit that produces the maximum amongst these weighted values. The coefficients can correspond to the base-10 value that would be encoded by the corresponding bit in the case of correct functioning of the sensor (i.e., if all circuits 12 from closest to the back plate up to the n^{th} were closed). For example, Table V shown at the end of the description illustrates such possible coefficients associated to the bits of the binary code.

Once the wear degree of the brake pad has been identified by selecting the most significant bit amongst the bits having a logic value “1” in the binary code produced in step 302, the microprocessor 180 determines, in step 306, the temperature of the brake pad by selecting, as reading sensor, the detection circuit 12 that comprises a resistance thermometer and that corresponds to the bit having the greatest weight (i.e., the most significant one) amongst the bits having a logic value “1” in the binary code produced at step 302. In other words, if the bit corresponding to the resistance thermometer Te90 is equal to “1”, the resistance thermometer Te90 is chosen as the temperature reading sensor. Next, if the bit corresponding to the resistance thermometer Te90 is equal to “0” and the bit corresponding to the track Pi70 is equal to “1”, the resistance thermometer Te50 is chosen if the corresponding bit is equal to “1”, alternatively the resistance thermometer Te10 if the corresponding bit is equal to “1”, and as a last alternative the resistance thermometer TeBP if the corresponding bit is equal to “1”. If the bit corresponding to the last resistance thermometer TeBP is also equal to “0” (which may correspond to an error or fault), the sensor determines that it is impossible to detect the temperature as all the resistance thermometers are out of order.

Subsequently, if the bit corresponding to the track Pi70 is equal to “0” and the bit corresponding to the resistance thermometer Te50 is equal to “1”, the resistance thermometer Te50 is chosen. Subsequently, if the bit corresponding to the resistance thermometer Te50 is equal to “0” and the bit corresponding to the track Pi30 is equal to “1”, the resistance thermometer Te10 is chosen if the corresponding bit is equal to “1”, and alternatively the resistance thermometer TeBP if the corresponding bit is equal to “1”. If the bit corresponding to the last resistance thermometer TeBP is also equal to “0”, the sensor determines that it is impossible to detect the temperature as all the resistance thermometers are out of order. Subsequently, if the bit corresponding to the track Pi30 is equal to “0” and the bit corresponding to the resistance thermometer Te10 is equal to “1”, the resistance thermometer Te10 is chosen. Next, if the bit corresponding to the resistance thermometer Te10 is equal to “0” and the bit corresponding to the track Pi0 or PiW is equal to “1”, the resistance thermometer TeBP is chosen if the corresponding bit is equal to “1”. If the bit corresponding to the last resistance thermometer TeBP is also equal to “0”, the sensor determines that it is impossible to detect the temperature as all the resistance thermometers are out of order.

In step 308, the microprocessor 180 calculates the base-10 value corresponding to the binary code produced in step 302, and compares it to the allowable numerical values stored in the memory area. If the calculated value corresponds to one of the allowable numerical values, the sensor is functioning correctly (i.e., there is no “anomalous” interruption of the detection circuits 12). If the calculated value does not correspond to any of the stored numerical values, then the sensor has a fault in at least one of the detection circuits 12, and an error message is produced, which is conveyed to the driver of the vehicle-together with the wear and temperature information-via the signal S.

By way of example, the case wherein the binary code produced at step 302 is equal to “11011111” is analyzed here, as illustrated in Table VI shown at the end of the description. In this case, the detection unit indicates that the thickness of the brake pad is still greater than 90% of the usable thickness (since the circuit Te90 is electrically continuous) and detects the temperature based on the resistance of the resistance thermometer Te90 (again as the circuit Te90 is electrically continuous), but at the same time indicates to the driver that the sensor has a fault (as the circuit Te50 is electrically discontinuous despite the circuits Te90 and Pi70 being electrically continuous).

Of course, notwithstanding the principle of the invention, the construction details and the embodiments may vary widely with respect to what has been described and illustrated purely by way of example, without thereby departing from the scope of the present invention, as defined in the attached claims.

TABLE I

| Te90 | Pi70 | Te50 | Pi30 | Te10 | Pi0 | PiW | TeBP | |
|---|---|---|---|---|---|---|---|---|
| 1 | 1 | 1 | 1 | 1 | 1 | 1 | 1 | =255 |

TABLE II

| Te90 | Pi70 | Te50 | Pi30 | Te10 | Pi0 | PiW | TeBP | |
|---|---|---|---|---|---|---|---|---|
| 0 | 1 | 1 | 1 | 1 | 1 | 1 | 1 | =127 |

TABLE III

| Te90 | Pi70 | Te50 | Pi30 | Te10 | Pi0 | PiW | TeBP | |
|---|---|---|---|---|---|---|---|---|
| 0 | 0 | 0 | 0 | 0 | 0 | 1 | 1 | =3 |

TABLE IV

| Te90 | Pi70 | Te50 | Pi30 | Te10 | Pi0 | PiW | TeBP | |
|---|---|---|---|---|---|---|---|---|
| 1 | 1 | 1 | 1 | 1 | 1 | 1 | 1 | =255 |
| 0 | 1 | 1 | 1 | 1 | 1 | 1 | 1 | =127 |
| 0 | 0 | 1 | 1 | 1 | 1 | 1 | 1 | =63 |
| 0 | 0 | 0 | 1 | 1 | 1 | 1 | 1 | =31 |
| 0 | 0 | 0 | 0 | 1 | 1 | 1 | 1 | =15 |
| 0 | 0 | 0 | 0 | 0 | 1 | 1 | 1 | =7 |
| 0 | 0 | 0 | 0 | 0 | 0 | 1 | 1 | =3 |
| 0 | 0 | 0 | 0 | 0 | 0 | 0 | 1 | =1 |

TABLE V

| | MSB | | | | | | | LSB |
|---|---|---|---|---|---|---|---|---|
| | Te90 | Pi70 | Te50 | Pi30 | Te10 | Pi0 | PiW | TeBP |
| Coefficient | 255 | 127 | 63 | 31 | 15 | 7 | 3 | 1 |

TABLE VI

| | | Port | | | | |
|---|---|---|---|---|---|---|
| | | (binary | | | Residual | Temperature |
| | | code) | Coeff | Port*Coeff | thickness | sensor |
| MSB | Te90 | 1 | 255 | 255 | >90% | Te90 |
| | Pi70 | 1 | 127 | 127 | | |
| | Te50 | 0 | 63 | 0 | | |
| | Pi30 | 1 | 31 | 31 | | |
| | Te10 | 1 | 15 | 15 | | |
| | Pi0 | 1 | 7 | 7 | | |
| | PiW | 1 | 3 | 3 | | |
| LSB | TeBP | 1 | 1 | 1 | | |

1. A method of detecting wear and temperature of a braking member of a vehicle, comprising:
sensing resistance values of a set of detection electric circuits arranged in ordered sequence along an axis of a detection sensor, wherein each detection circuit of said set of detection electric circuits comprises a respective wear detector of the braking member, and each detection electric circuit in a subset of said set of detection electric circuits comprises a respective temperature detector of the braking member, wherein a first detection electric circuit of said set of detection electrical circuits of said ordered sequence is arranged towards a rubbing surface of said braking member and a last detection electric circuit of said set of detection electrical circuits of said ordered sequence is arranged towards a support back plate of said braking member;
producing an N-bit binary sequence, N being a number of said detection electric circuits, wherein the bits of said N-bit binary sequence are orderly associated, from a most significant bit to a least significant bit, to said ordered sequence of said set of detection electric circuits, and wherein each bit of said N-bit binary sequence takes on a first logic value if a corresponding detection electric circuit is electrically continuous and a second logic value if the corresponding detection electric circuit is electrically interrupted;
identifying, in said N-bit binary sequence, a most significant bit amongst the bits having said first logic value, and determining a wear degree of said braking member as a function of a position of said identified bit in said N-bit binary sequence;
identifying, in a subset of said N-bit binary sequence corresponding to said subset of said set of detection electric circuits, a further most significant bit amongst the bits having said first logic value, and determining the temperature of said braking member as a function of a resistance of the temperature detector associated to the detection electric circuit corresponding to said further most significant bit;
storing a set of allowable cases for said N-bit binary sequence;
comparing said N-bit binary sequence to said stored set of allowable cases; and
producing an error message if said N-bit binary sequence does not correspond to any of said stored set of allowable cases.

2. The method of claim 1, wherein the step of storing said set of allowable cases for said N-bit binary sequence comprises storing base-10 values corresponding to sequences where the bits having said second logic value, if present, are consecutive and arranged starting from the most significant bit of said N-bit binary sequence, and
wherein the step of comparing said N-bit binary sequence to said stored set of allowable cases comprises comparing the base-10 value of said N-bit binary sequence to said stored base values.

3. The method of claim 1, comprising storing a lookup table between the position of the bit in said N-bit binary sequence and the wear degree of the braking member, wherein the step of determining the wear degree of said braking member as a function of the position of said identified bit in said N-bit binary sequence comprises applying said lookup table.

4. The method of claim 1, wherein said first logic value is a logic “1” and said second logic value is a logic “0”, and wherein the step of identifying, in said N-bit binary sequence, the most significant bit amongst the bits having said first logic value comprises:
multiplying each bit of said N-bit binary sequence times a corresponding coefficient, said corresponding coefficients having respective values that increase as a significance of the bit of the N-bit binary sequence increases, producing a set of weighted values;
identifying the maximum value amongst said weighted values; and
selecting, as the most significant bit amongst the bits having said first logic value, the bit of the N-bit binary sequence that produces said maximum value amongst said weighted values.

5. The method of claim 1, wherein the step of identifying, in said N-bit binary sequence, the most significant bit amongst the bits having said first logic value comprises examining values of the bits of said N-bit binary sequence starting from the most significant bit and stopping the examination as soon as a bit having said first logic value is detected.

6. The method of claim 1, wherein the most significant bit of said N-bit binary sequence is associated to the first detection electric circuit and the least significant bit of said N-bit binary sequence is associated to the last detection electric circuit.

7. The method of claim 1, wherein said first logic value is a logic “1” and said second logic value is a logic “0”.

8. A detection unit for wear and temperature of a braking member of a vehicle, comprising a detection sensor, an electrical connector configured to connect the detection unit to an electronic control unit of the vehicle, and an electrical wiring configured to connect the detection sensor to the electrical connector;
wherein the detection sensor-comprises:
a body having a longitudinal axis and configured to be inserted into the braking member; and
a set of detection electric circuits arranged in said body in an ordered sequence along said longitudinal axis, said set of detection electric circuits having respective first terminals all electrically coupled to a conductive track arranged in said body of the detection sensor and configured to receive a first power supply voltage, and respective second terminals electrically isolated amongst each other and configured to receive a second power supply voltage,
wherein each detection circuit of said set of detection electric circuits comprises a respective wear detector of said braking member, and each of said detection electric circuits in a subset of said set of detection electric circuits comprises a respective temperature detector of said braking member, wherein a first detection electric circuit of said set of detection electrical circuits of said ordered sequence is arranged towards a rubbing surface of said braking member and a last detection electric circuit of said set of detection electrical circuits of said ordered sequence is arranged towards a support back plate of said braking member;
and wherein the electrical connector comprises a microprocessor coupled to said detection electric circuits to sense their respective resistance values and a transceiver coupled to said microprocessor, said microprocessor being configured to operate according to the method of claim 1, and said transceiver being configured to transmit a message indicative of the wear degree and temperature of said braking member to an electronic control unit of said vehicle.

9. The detection unit of claim 8, wherein said set of detection electric circuits comprises:
the first detection circuit, comprising its respective wear detector and its respective resistance thermometer, arranged at 90% of the usable thickness of said braking member;
a second detection circuit, comprising its respective wear detector, arranged at 70% of the usable thickness of said braking member;
a third detection circuit, comprising its respective wear detector and a its respective resistance thermometer, arranged at 50% of the usable thickness of said braking member;
a fourth detection circuit, comprising its respective wear detector, arranged at 30% of the usable thickness of said braking member;
a fifth detection circuit, comprising its respective wear detector and a its respective resistance thermometer, arranged at 10% of the usable thickness of said braking member;
a sixth detection circuit, comprising a its respective wear detector, arranged at 0% of the usable thickness of said braking member;
a seventh detection circuit, comprising its respective wear detector, arranged between 0% of the usable thickness of said braking member and the support back plate of said braking member; and
an eighth detection circuit, comprising a its respective wear detector and its respective resistance thermometer, arranged at said support back plate of said braking member.

10. A computer program product loadable into a memory of at least one processing device, and comprising software code instructions which, when the computer program product is executed by said at least one processing device, causes the at least one processing device to carry out the method of claim 1.
